(19) United States
(12) Patent Application Publication
(10) Pub. No.: US 2014/0178657 A1
(43) Pub. Date: Jun. 26, 2014

(54) ANTIREFLECTION COATINGS

(71) Applicant: INTERMOLECULAR INC., San Jose, CA (US)

(72) Inventors: Scott Jewhurst, Redwood City, CA (US); Nikhil Kalyankar, Mountain View, CA (US)

(73) Assignee: INTERMOLECULAR INC., San Jose, CA (US)

(21) Appl. No.: 13/723,954

(22) Filed: Dec. 21, 2012

(51) Int. Cl. B32B 7/02; B05D 5/06

(52) U.S. Cl. CPC B32B 7/02; B05D 5/06
USPC 428/212; 427/165

(57) ABSTRACT

Fluorine-doped antireflection coatings, methods for preparing the coatings and articles comprising the coatings are disclosed. The fluorine-doped antireflection coating comprises a fluorine-doped xerogel coating disposed on a substrate. The index of refraction of the xerogel coating is less than the index of refraction of the substrate, generally between about 1.15 and about 1.45. The fluorine atoms can be distributed uniformly through the thickness of the coating, disposed at the surface of the coating, or the distribution can be graded from the surface through the thickness of the coating. The methods comprise applying a coating precursor solution comprising a sol-gel precursor to a glass substrate, heating the coating to form a xerogel coating, and fluorine-doping the coating. The fluorine-doping can be performed by utilizing a coating precursor solution comprising a first fluorine source, contacting the cured coating with a second fluorine source, or a combination thereof.

### CROSS REFERENCE TO RELATED APPLICATIONS

This application is related to commonly owned U.S. patent application Ser. No. 12/970,638, filed on Dec. 16, 2010, Ser. No. 13/046,899, filed on Mar. 14, 2011, Ser. No. 13/072,860, filed on Mar. 28, 2011, Ser. No. 13/041,137, filed on Mar. 4, 2011, Ser. No. 13/195,119, filed on Aug. 1, 2011, Ser. No. 13/195,151, filed on Aug. 1, 2011, Ser. No. 13/273,007, filed on Oct. 13, 2011, and Ser. No. 13/686,044, filed on Nov. 27, 2011, each of which are herein incorporated by reference.

### FIELD OF THE INVENTION

One or more embodiments of the present invention relate to durable antireflection coatings and methods of forming the coatings.

### BACKGROUND

Antireflection coatings are well known for the purpose of reducing reflectance and increasing transmittance at material boundaries. The coatings can be either single-layer or multi-layer, and generally comprise materials whose index of refraction is intermediate between those of the materials on either side of the boundary.

Various materials can be used to make antireflection coatings. For glass-air boundaries, sol-gels are frequently used, because they have a high air fraction and therefore lower index of refraction than the bulk material. Typical glasses have an index of refraction of about 1.5, and air has an index of refraction of approximately 1.0. As sol-gels can incorporate air-filled pores into the finished coating, they can be used to prepare coatings having an intermediate index of refraction. As long as the coating thickness and the pore sizes are smaller than the wavelength of light, the inhomogeneous structure of the material does not adversely impact its transparency.

Antireflection coatings can be susceptible to degradation due to contact with moisture, alkaline and acidic environments, salt and UV radiation. Attempts to provide enhanced durability have been made. Prior approaches have utilized a reduction in specific surface area and porosity in order to decrease the reactivity of the coating with water and other corrosive agents. However, a decrease in specific surface area with a reduction in porosity through increasing the contact area between particles (on average), results in an increase in mechanical and chemical durability, at the cost of an increase in refractive index, and can result in an increase in reflectivity, impairing the ability of the coating to act as an antireflection coating. Further, the chemical affinity of silica for water or other agents of corrosion is not affected by this treatment.

Additional efforts have focused on deposition of an inorganic (e.g. TiO₂) or organic (e.g., fluoropolymer) capping layer or conformal coating to act as a functional barrier coating preventing direct contact of moisture or other corrosive agents with the silica. However, deposition of capping layers results in an increase in refractive index, either by loss of air-filled pore volume by use of the higher refractive index capping layer, or by creation of an interference layer. Therefore, this approach can also result in an increase in reflectivity, impairing the ability of the coating to act as an antireflection coating. In addition, this approach requires a second coating process to implement. Further problems include the possible failure of capping layers: if the chemical barrier function is breached even on a small area, moisture will be drawn in through the breach by capillary action.

Latthe describes the synthesis of superhydrophobic silica films on glass substrates. Using trimethylethoxysilane as a precursor, sol-gel coatings could be prepared on glass substrates with water-repelling properties without any addition of fluorine-containing compounds. (Latthe, S., et al. 2009 Appl. Surf. Sci. 256, 217). However, these coatings have poor mechanical durability due to the presence of the Si—CH₃ bonds and incomplete silanol-to-siloxane conversion: the skeletal density (Si—O—Si bonds) is decreased. In addition, interfacial adhesion is decreased because the methyl groups cannot participate in adhesion with glass and are actually repellent to the polar glass surface, reducing adhesion to the glass.

Shibata describes the use of a sol-gel method for creating fluorine doped silica gel to be used in fabrication of optical fibers (Shibata, S., et al., 1988 Journal of Non-Crystalline Solids 100, 269-73). However, this reference discusses fluorine doping of the inner cladding of optical fibers to provide a lower refractive index in order to increase signal propagation, and does not discuss the chemical or mechanical properties of such fluorine-doped materials, nor their use in anti-reflective coatings or thin films. Such fluorine doped optical fibers are not porous and could not be used in antireflection coatings.

Similarly, Maehana describes a sol-gel method for creating fluorine doped silica gel monoliths to increase transmittance of light in fiber optics using HF as catalyst and fluorine source. (Maehana, R., et al., 2011 Journal of the Ceramics Society of Japan 119, 393-396). Fluorine substitution for silanol hydroxyl was studied. However, Maehana's teachings are limited to depleting hydroxyl groups in silica glasses for improved light transmittance and other functional optical properties, with no mention of affects on chemical or mechanical properties or use in anti-reflection coatings or thin films.

Wang et al. describes the preparation of superhydrophobic surfaces with water contact angles over 170° and sliding angles below 7° by coating a particulate silica sol solution of cohydrolyzed tetraethoxysilane/fluorinated alkyl silane with NH₃.H₂O on textile fabrics (e.g., polyester, wool and cotton) and glass slides. (Wang, H., et al. 2008 Chem. Commun. 877). This treatment generates particles of average size 50-150 nm on the substrate having pendant fluorinated alkyl groups which impart hydrophobicity.

U.S. Pat. No. 3,314,772 to Poole describes methods for improving corrosion resistance of bulk soda-lime glasses by fluorine doping with aqueous HF solutions or by pyrolysis of C_{F4} or Freon gases. However, this use of aqueous HF leaches the glass to selectively extract the soluble Na₂O and CaO components of soda-lime glass responsible for glass corrosion, and would damage a silica xerogel coating. In addition, the pyrolysis of CF₄ or Freon to fluorine dope a silica xerogel could result in undesired densification (increased refractive index) if temperature and duration is excessive.

Nassau describes the use of fluorine doping of bulk sol-gel silica to reduce shrinkage and swelling and to create a hydrophobic surface. (Nassau, K. et al. 1986 Journal of Non-Crystalline Solids 82, 78-85). However, this reference is only relevant to creation of bulk glasses from melting of F-doped sol-gel monoliths. The objectives in creation of bulk glasses are very different from those involved in preparing thin film antireflection coatings, as preparation of bulk glasses relates to the elimination of porosity and voids during the melt, while antireflection coatings require porosity and voids for achieving the desired index of refraction.

### SUMMARY OF THE INVENTION

Antireflection coatings, methods for preparing the coatings and articles comprising the coatings are disclosed. The antireflection coatings comprise a xerogel coating comprising silica doped with fluorine disposed on a substrate. Typical substrates include transparent substrates such as glass. The index of refraction (RI) of the cured coating is less than the RI of the glass substrate. In some embodiments, the RI of the coating is approximately equal to the square root of the RI of the substrate at wavelengths of interest. In some embodiments, the RI of the coating is within 5% of the RI of the substrate at wavelengths of interest. For example, the RI of the coating can be in the range of 1.15 to 1.45 and the substrate can be glass having a RI of 1.5. In some embodiments, the RI of the coating is intermediate between that of air and the glass. The reflectance from the side of the substrate with the cured antireflection coating is reduced by at least 50%. The antireflection coating can further comprise particles, such as silica nanoparticles, which can be porous or nonporous as desired. The RI of the particles can be the same as, greater than, or less than the index of refraction of the substrate.

The antireflection coating comprises silica and from about 0.1 to about 5% (wt/wt) fluorine. The fluorine is present in the form of metal-F bonds (e.g., Si—F), and the absence of C—F bonds, i.e., unlike many anti-soiling materials, embodiments of the instant antireflection coating do not contain C—F bonds. The surface of the cured coating contains terminal fluorine-silicon bonds. The thickness of the antireflection coating is from about 100 to about 200 nm. In some embodiments, the thickness of the antireflection coating is from about 120 to about 160 nm.

In some embodiments, the fluorine atoms are distributed uniformly through the thickness of the coating. In some embodiments, the fluorine atoms are disposed at the surface of the coating. In some embodiments, the fluorine atom distribution is graded from the surface through the thickness of the coating. For example, the antireflection coating can comprise fluorine throughout the thickness of the coating, but have a higher concentration of fluorine atoms at the surface of the coating.

Methods of making antireflection coatings on a glass substrate are disclosed. The methods comprise applying a coating precursor solution comprising a sol-gel precursor to a glass substrate, heating the coating precursor solution to form a xerogel coating, and fluorine-doping the coating. The fluorine-doping can be performed by one or more of the following: utilizing a coating precursor solution comprising a first fluorine source, contacting the xerogel coating with a second fluorine source, or a combination thereof.

The first fluorine source can be a fluorinated sol-gel precursor, a fluorogenic precursor, a soluble fluoride compound, or mixtures thereof. Using these methods, the fluorine atoms are generally distributed uniformly through the thickness of the coating. When fluorinated sol-gel precursors are utilized, the fluorine doping is performed by direct incorporation of F—Si bonds into the xerogel coating. Fluorinated sol-gel precursors typically include fluorosilanes such as FSi(OR)₃, where R is a lower alkyl, FSiCl₃, or silicon trifluoroacetate. Exemplary fluorosilanes include fluorotrialkoxysilanes such as fluorotriethoxysilane, and fluorohalosilanes such as fluorotrichlorosilane.

When fluorogenic precursors are utilized, the fluorine doping is performed by reaction of reactive fluorine species during the curing process, which results in incorporation of F—Si bonds into the xerogel coating. Fluorogenic precursors include fluorogenic species that generate reactive fluorine atoms or molecules upon combustion or thermal decomposition that occurs during the curing process. In some embodiments, the fluorogenic precursor is a fluorinated alcohol, fluorinated carboxylic acid, fluorinated amine, fluorinated surfactant, or fluoride.

When soluble fluoride compounds are utilized, the fluorine doping is performed by reaction of reactive fluorine species during the curing process, which results in incorporation of F—Si bonds into the xerogel coating. Soluble fluoride compounds that can be used include fluoride salts such as NH₄F, HF, F₂, H₂SiF₆, NH₄HF₂, C(NH₂)₃F. When HF is used, it is used with a nonaqueous solvent.

In some embodiments, the fluorine doping is performed by contacting the xerogel coating with a second fluorine source, which can be a reactive fluorine gas, liquid, or plasma. Using these methods, the fluorine atoms are generally disposed at the surface of the coating. In some embodiments, the second fluorine source is CF₄, C₂F₆, COF₂ or HF(g). The contacting step can be performed at temperatures of 10-300° C., and introduces Si—F bonds into the coating. As a result of fluorine-doping, the surface of the cured coating contains terminal Si—F bonds.

In some embodiments, the antireflection coating can be prepared by a combination of utilizing a coating precursor solution comprising a first fluorine source, and contacting the xerogel coating with a second fluorine source. Using these methods, the fluorine atoms can be generally distributed uniformly through the thickness of the coating and but with a higher concentration at the surface. The distribution of the fluorine atoms can be graded through the coating thickness.

The coating precursor solution can further comprise an acid catalyst, a base catalyst, water, a nonaqueous solvent, or mixtures thereof. In some embodiments, the coating precursor solution further comprises nanoparticles. In some embodiments, the nanoparticles comprise silica and have a defined size distribution. The particles can have a diameter in the smallest dimension of 2-100 nm, and a diameter in the largest dimension of 15 to 200 nm. In some embodiments, the particles are approximately spherical and the mean particle size is in the range of from 10 to 50 nm. In some embodiments, the particles are non-spherical, and can have much longer lengths on the long axis (400+nm). In some embodiments, the particles are formed in the sol-gel solution. In some embodiments, the particles are added to the sol-gel solution. The particles can be porous or nonporous.

The coating precursor solution can further comprise a porogen. Porogens include surfactants, polymers, or water immiscible solvents such as xylene, fluoroalkanes, or hydrophobic silicone fluids. In some embodiments, the porogen is a surfactant such as Sylwet L-77 and is added to the coating precursor solution at a weight % from 0.001 to 10%. In some embodiments, the porogen is a polymer such as polyethylene glycol and is added to the coating precursor solution at a weight % of 0.001 to 5%. Other polymers such as PVA, PVP and hydroxypropyl cellulose are also used. In some embodiments, hydroxylated fluoropolymers such as ACG Lumiflon can be utilized as porogens. In this embodiment, the fluorinated porogen can also serve as a fluorogenic precursor and result in fluorine doping during curing to form the xerogel.

The coating precursor solution can be applied to the glass substrate using any convenient method, such as one or more methods selected from dip-coating, spin coating, spray coating, roll coating, or curtain coating. After application to the substrate, the coating precursor solution is heated to a temperature of at least 300° C., typically in the range of from about 300° C. to about 900° C. The coating precursor solution and substrate can be heated together, or the coating may be selectively heated using methods such as IR laser annealing, UV RTP, or microwave processing.

In some embodiments, articles of manufacture are provided comprising a glass substrate having a fluorine-doped antireflection coating. The article can be float glass, window glass, cover glass, the glass superstrate for a solar cell, textured (rolled and patterned) glass, crown glass, electronic display, or optical device such as a lens or prism. Other articles of manufacture will be readily apparent to those of skill in the art.

### BRIEF DESCRIPTION OF THE DRAWINGS

FIG. 1 shows a block diagram for preparation of a fluorine doped antireflection coating according to one embodiment of the present invention.

FIG. 2 shows a block diagram for preparation of a fluorine doped antireflection coating according to one embodiment of the present invention.

FIG. 3 shows a block diagram for preparation of a fluorine doped antireflection coating according to one embodiment of the present invention.

FIG. 4 shows a block diagram for preparation of a fluorine doped antireflection coating according to one embodiment of the present invention.

### DETAILED DESCRIPTION

Before the present invention is described in detail, it is to be understood that unless otherwise indicated this invention is not limited to specific coating compositions or specific substrate materials. Exemplary embodiments will be described for selected sol-gel coatings on soda-lime glass, but other coating formulations and other types of glasses and transparent substrates can also be used. It is also to be understood that the terminology used herein is for the purpose of describing particular embodiments only and is not intended to limit the scope of the present invention.

It must be noted that as used herein and in the claims, the singular forms “a,” “and” and “the” include plural referents unless the context clearly dictates otherwise. Thus, for example, reference to “a layer” includes two or more layers, and so forth.

Where a range of values is provided, it is understood that each intervening value, to the tenth of the unit of the lower limit unless the context clearly dictates otherwise, between the upper and lower limit of that range, and any other stated or intervening value in that stated range, is encompassed within the invention. The upper and lower limits of these smaller ranges may independently be included in the smaller ranges, and are also encompassed within the invention, subject to any specifically excluded limit in the stated range. Where the stated range includes one or both of the limits, ranges excluding either or both of those included limits are also included in the invention. Where the modifier “about” or “approximately” is used, the stated quantity can vary by up to 10%. Where the modifier “substantially” is used, the two quantities may vary from each other by no more than 5%.

### DEFINITIONS

The term “curing” as used herein refers to a treatment (generally with heat) that induces condensation bonding (i.e., cross-linking) between Si atoms in sol-gels to form a silica xerogel.

The term “fluorine doped” (or “F-doped”) or “doped with fluorine” as used herein refers to the covalent incorporation of fluorine as Si—F bonds into the coating in an amount of about 0.1% to about 5% by weight.

The term “heat treating” as used herein refers to a treatment with heat that can allow stress relaxation, viscous flow, sintering, decrease in porosity, etc. in a coating or glass article.

The term “metal” as used herein refers to metals (e.g., aluminum) and metalloids (e.g., silicon, germanium).

The term “porosity” as used herein refers to a measure of the void spaces in a material, and may be expressed as a fraction, the “pore fraction” of the volume of voids over the total volume. Porosity is typically expressed as a number between 0 and less than 1, or as a percentage between 0 to less than 100%.

The term “surface” as used herein refers to the air-material interface formed by a sol-gel or coatings made therefrom. A surface can be disposed at an interior pore or at an outer boundary of the porous material.

The term “Si—F terminated” as used herein refers to the spatial arrangement of atoms at the air-material interface wherein the fluorine atoms are preferentially oriented toward air and away from the bulk of the material. Si—F termination can also be present in the coating interior, and would define a break in the —Si—O—Si— network.

The term “sol-gel process” as used herein refers to a process where a wet formulation (the “sol”) forms a gel coating comprised of a solid network containing a liquid phase composed primarily of solvent species, water and catalyst. The gel coating is then heat treated to remove the liquid phase and leave a strongly crosslinked solid material, which may be porous. The sol-gel process is valuable for the development of coatings because it is easy to implement and provides films of uniform composition and thickness.

The term “surfactant” as used herein refers to a compound that lowers the surface tension of a liquid and contains both hydrophobic groups and hydrophilic groups. Thus the surfactant contains both a water insoluble component and a water soluble component.

The term “silane surfactant” refers to a compound having a hydrophilic silane moiety which can react with silanol residues on glass or cured sol-gel surfaces, and having a hydrophobic moiety such as an alkyl. The silane surfactant can be used in a surface modification for reducing soiling on glass surfaces.

The term “total ash content” as used herein refers to the amount of inorganic components remaining after combustion of the organic and volatile matter in the sol formulation by subjecting the sol formulation to high temperatures. Exemplary inorganic materials remaining after combustion of the organic matter for a sol formulation described herein typically include silica from particles and silica from binder. However, other inorganic materials, for example, fluorine, may also be present in the total ash content after combustion. The “total ash content” is typically obtained by the following method:

1. Exposing a known quantity of a sol formulation to high temperatures greater than 600° C. to combust the organic matter.

2. Weighing the leftover inorganic material (referred to as “ash”).

The total ash content is calculated from the following formula: total ash content (wt. %) of the sol formulation=(Weight of ash (g)/original weight of the sol formulation (g))×100.

The term “xerogel” as used herein refers to the solid network formed from a sol-gel process which remains after solvents and other swelling agents have been removed.

Antireflection coatings, methods for preparing the coatings and articles comprising the antireflection coatings are disclosed. The antireflection coatings comprise a silica xerogel coating comprising silica doped with fluorine disposed on a transparent substrate. The antireflection coating has an average thickness of between about 100 nm and about 200 nm. In some embodiments, the thickness of the antireflection coating is from about 120 to about 160 nm.

Typical substrates include transparent substrates such as glass. The index of refraction (RI) of the fluorine doped silica xerogel coating is less than the RI of the glass substrate. In some embodiments, the RI of the coating is approximately equal to the square root of the RI of the substrate at wavelengths of interest. In some embodiments, the RI of the coating is within 5% of the RI of the substrate at wavelengths of interest. For example, the RI of the coating can be in the range of 1.15 to 1.45 and the substrate can be glass having a RI of 1.5. In some embodiments, the RI of the coating is intermediate between that of air and the glass. The reflectance from the surface with the cured coating is reduced by at least 50% compared to the substrate surface without the antireflection coating. The antireflection coating can further comprise particles, such as silica nanoparticles, which can be porous or nonporous as desired. The RI of the particles can be the same as, greater than, or less than the index of refraction of the substrate.

The antireflection coating comprises silica and is doped with fluorine from about 0.1 to about 5% (wt/wt) fluorine. The fluorine is present in the form of metal-fluorine bonds (e.g., Si—F), and the absence of C—F bonds. Unlike many anti-soiling materials, embodiments of the instant antireflection coating do not contain C—F bonds. The metal-fluorine bonds are very strong due to the extreme electronegativity of fluorine, resulting in resistance to acid and other chemical attack and resistance to radiation damage. As a result of fluorine-doping, the surface of the xerogel coating contains terminal fluorine-silicon bonds which impart a hydrophobic character and provide resistance to soiling in addition to resistance to chemical and radiation-induced damage.

In some embodiments, the fluorine atoms are distributed uniformly through the thickness of the coating. In some embodiments, the fluorine atoms are disposed at the surface of the coating. In some embodiments, the fluorine atom distribution is graded from the surface through the thickness of the coating. For example, the antireflection coating can comprise fluorine throughout the thickness of the coating, but have a higher concentration of fluorine atoms at the surface of the coating.

Methods of making antireflection coatings on a glass substrate are disclosed. The methods comprise applying a coating precursor solution comprising a sol-gel precursor to a glass substrate, heating the coating precursor solution to form a xerogel coating, and fluorine-doping the coating. The fluorine-doping can be performed by one or more of the following: utilizing a coating precursor solution comprising a first fluorine source, contacting the xerogel coating with a second fluorine source, or a combination thereof.

Methods of increasing the durability and hydrophobicity of an antireflection coating are provided. The methods comprise fluorine-doping a silica xerogel coating. The amount of fluorine doping is effective to reduce soiling, and increase durability, for example, against chemical and radiation damage. The antireflection coating exhibits anti-soiling and improved durability against one or more of moisture, corrosion, acid, base, ultraviolet light, or combinations thereof. For example, the antireflection coatings exhibit increased chemical resistance (to water, alkaline conditions, salt, UV) due to the decreased solubility of the coating by elimination of silanols (Si—OH) responsible for formation of soluble species. In addition, the antireflection coatings exhibit improved chemical resistance to aqueous solutions, which is due to the increased hydrophobicity and decreased specific surface area due to thickening of interparticle contacts (necks) in the xerogel coating. By forming the hydrophobic surface (e.g., fluorine-doping) in the same coating and annealing operation, less stress is added to the substrate (e.g., glass) by subsequent heating and processing steps, and any stress present due to capillary forces is relieved. Further, the method can improve the efficiency of the manufacturing process.

In some embodiments, articles of manufacture are provided comprising a substrate having a fluorine-doped silica xerogel antireflection coating. The substrate is a transparent substrate and can be a glass (e.g., an amorphous solid) or crystalline. For example, the article can be float glass, window glass, cover glass, the glass superstrate for a solar cell, textured (rolled and patterned) glass, crown glass, electronic display, or optical device such as a lens or prism. Other articles of manufacture will be readily apparent to those of skill in the art.

### Methods of Forming Fluorine-Doped Antireflection Coatings

Methods of making antireflection coatings on a glass substrate are disclosed. The methods comprise applying a coating precursor solution comprising a sol-gel precursor to a glass substrate, heating the coating precursor solution to form a xerogel coating, and fluorine-doping the coating. The fluorine-doping can be performed by one or more of the following: utilizing a coating precursor solution comprising a first fluorine source, contacting the xerogel coating with a second fluorine source, or a combination thereof.

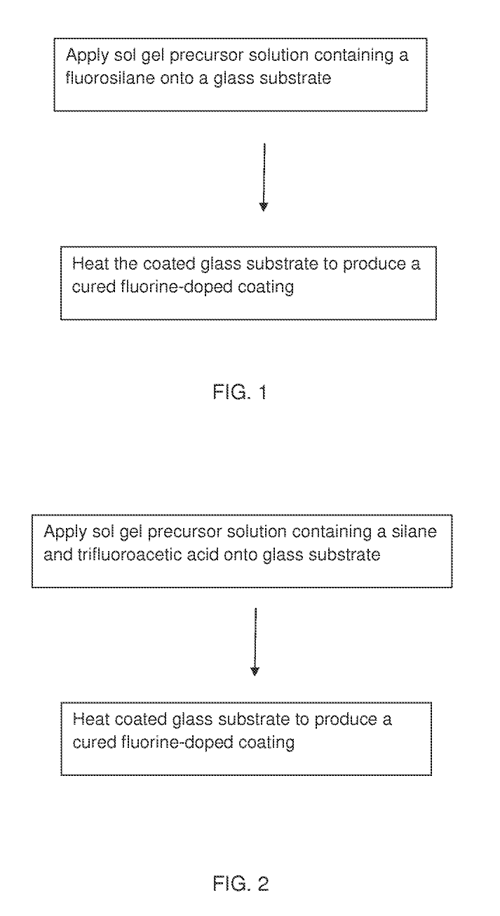

In some embodiments, a coating precursor solution comprising a first fluorine source having a preexisting Si—F bond is utilized to form the antireflection coating. The substrate is heated, curing the coating to form a xerogel, which is fluorine-doped due to the incorporation of Si—F bonds in the coating. The first fluorine source can be a fluorinated sol-gel precursor, a fluorogenic precursor, a soluble fluoride compound, or mixtures thereof. For example, the coating precursor solution can comprise a fluorosilane. This embodiment is depicted schematically in FIG. 1.

Using these methods, the fluorine atoms are generally distributed uniformly through the thickness of the coating. When fluorinated sol-gel precursors are utilized, the fluorine doping is performed by direct incorporation of F—Si bonds into the xerogel coating. Fluorinated sol-gel precursors typically include fluorosilanes such as FSi(OR)₃, where R is lower alkyl, FSiCl₃, or silicon trifluoroacetate. Exemplary fluorosilanes include fluorotrialkoxysilanes such as fluorotriethoxysilane, and fluorohalosilanes such as fluorotrichlorosilane.

In some embodiments, a coating precursor solution comprising fluorogenic precursors that evolve reactive fluorine species during the curing process can be used to form the fluorine-doped antireflection coating. When fluorogenic precursors are utilized, the fluorine doping is performed by reaction of reactive fluorine species during the curing process, which results in incorporation of F—Si bonds into the xerogel coating. In some embodiments, the fluorogenic precursor is a fluorinated alcohol, fluorinated carboxylic acid, fluorinated amine, fluorinated surfactant, or fluoride. For example, a silane and trifluoroacetic acid (TFA) can be applied to a substrate. Fluorine is incorporated into the coating during heat treatment of the coating, thermally decomposing the TFA into a variety of fluorine containing reactive gases that react with Si—OH groups, CO₂, CO and H₂O vapor. The substrate is heated, curing the coating, which is fluorine-doped due to the incorporation of Si—F bonds in the coating. This embodiment is depicted schematically in FIG. 2.

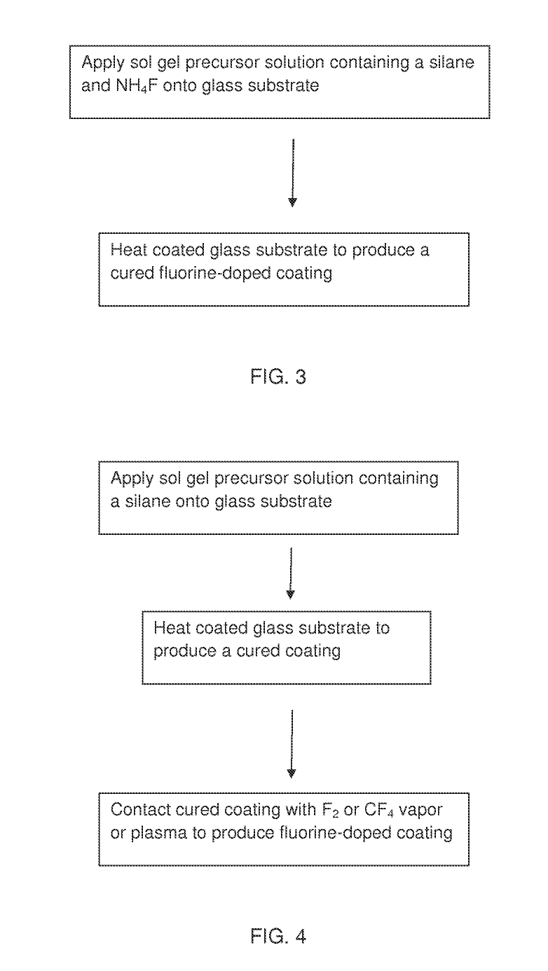

In some embodiments, a coating precursor solution comprising soluble fluoride compounds that evolve reactive fluorine species during the curing process can be used to form the fluorine-doped antireflection coating. When soluble fluoride compounds are utilized, the fluorine doping is performed by reaction of reactive fluorine species during the curing process, which results in incorporation of F—Si bonds into the xerogel coating. Soluble fluoride compounds that can be used include fluoride salts such as NH₄F, HF, F₂, H₂SiF₆, NH₄HF₂, C(NH₂)₃F. When HF is used, it is used with a nonaqueous solvent. For example, a silane and a fluoride salt (e.g., NH₄F) can be applied to a substrate. During heat treatment of the coating, NH₄F is thermally decomposed into HF and NH₃ vapor, where the HF reacts with Si—OH to form Si—F bonds. The coating is fluorine-doped due to the incorporation of Si—F bonds in the coating during the process by substitution of F for OH in the silica. This embodiment is depicted schematically in FIG. 3.

In some embodiments, the fluorine doping is performed by contacting the xerogel coating with a second fluorine source, which can be a reactive fluorine gas, liquid, or plasma. Using these methods, the fluorine atoms are generally disposed at the surface of the coating. As a result of fluorine-doping, the surface of the cured coating contains terminal Si—F bonds. In some embodiments, the second fluorine source is CF₄, C₂F₆, COF₂ or HF(g). For example, a coating precursor solution comprising a silane can be applied to a substrate. The substrate is heated, curing the coating. Fluorine is incorporated into the coating by contacting the cured coating with fluorine species in the form of gases or plasmas, introducing Si—F bonds into the coating. For example F₂ or CF₄ vapor or CF₄ containing plasma discharge can be contacted with the cured or heat-treated coating at temperatures of 10-300° C. This embodiment is depicted schematically in FIG. 4.

In some embodiments, the antireflection coating can be prepared by a combination of utilizing a coating precursor solution comprising a first fluorine source, and contacting the xerogel coating with a second fluorine source. Using these methods, the fluorine atoms can be generally distributed uniformly through the thickness of the coating and but with a higher concentration at the surface. The distribution of the fluorine atoms can be graded through the coating thickness.

The coating precursor solution can further comprise an acid catalyst, a base catalyst, water, a nonaqueous solvent, or mixtures thereof. The choice of acid or base catalyst and solvent system can be chosen to provide desired solubility and reactivity of sol-gel precursors and achieve a desired porosity (and hence RI).

In some embodiments, the coating precursor solution further comprises nanoparticles, and the resulting antireflection coating comprises particles. The particles typically are silica nanoparticles, which can be porous or nonporous as desired. The particles can affect the RI and porosity of the cured coating, depending on the RI and porosity of the particles chosen, along with the RI and porosity of the coating. The RI of the particles can be the same as, greater than, or less than the index of refraction of the substrate. The RI of the entire coating is a weighted average of the volume of particles and pores governed by

(V_{particle}/Vₜₒₜₐₗ)RI_{particle}+(Vₚₒᵣₑ/Vₜₒₜₐₗ)RIₐᵢᵣ. (1)

Accordingly, the mixture of sol gel monomers, porogens, porosity of nanoparticles, etc. can be chosen to provide a desired antireflection coating RI.

In some embodiments, the nanoparticles comprise silica and have a defined size distribution. The particles can have a diameter in the smallest dimension of 2-100 nm, and a diameter in the largest dimension of 15 to 200 nm. In some embodiments, the particles are approximately spherical and the mean particle size is in the range of from 10 to 50 nm. In some embodiments, the particles are non-spherical, and can have much longer lengths on the long axis (400+nm). In some embodiments, the particles are formed in the sol-gel solution. In some embodiments, the particles are added to the sol-gel solution. The particles can be porous or nonporous.

In some embodiments, the coating precursor solution further comprises a porogen so that the cured coating is porous and has a lower refractive index than the glass substrate. Porogens include surfactants, polymers, or water immiscible solvents such as xylene, fluoroalkanes, or hydrophobic silicone fluids. In some embodiments, the porogen is a surfactant such as Sylwet L-77 and is added to the coating precursor solution at a weight % from 0.001 to 10%. In some embodiments, the porogen is a polymer such as polyethylene glycol and is added to the coating precursor solution at a weight % of 0.001 to 5%. Other polymers such as PVA, PVP and hydroxypropyl cellulose are also used. In some embodiments, hydroxylated fluoropolymers such as ACG Lumiflon can be utilized as porogens. In this embodiment, the fluorinated porogen can also serve as a fluorogenic precursor and result in fluorine doping during curing to form the xerogel.

The coating precursor solution can be applied to the glass substrate using any convenient method, such as one or more methods selected from dip-coating, spin coating, spray coating, roll coating, or curtain coating. The deposited thin films can then be heat treated to remove excess solvent, and annealed at an elevated temperature to create a polymerized network (e.g., —Si—O—Si—) and remove remaining solvent and water. After application to the substrate, the coating precursor solution is heated to a temperature of at least 300° C., typically in the range of from about 300° C. to about 900° C. The coating precursor solution and substrate can be heated together, or the coating may be selectively heated using methods such as IR laser annealing, UV RTP, or microwave processing.

### Coating Precursor Solutions

Fluorine-doped antireflection coatings can be applied as a coating precursor solution comprising a sol-gel precursor (e.g., a silane) to a surface, and annealed in place by heating to drive off solvents to form a gel. Further heating serves to drive off water and provide energy for the silane condensation reactions to form the finished coating. The coating precursor solution can further comprise one or more of an acid catalyst, a base catalyst, water, a nonaqueous solvent, or mixtures thereof. In some embodiments, the coating precursor solution can further comprise nanoparticles. The coating precursor solution can further comprise a porogen. Porogens include surfactants, polymers, water immiscible solvents, for example.

Sol-gel precursors include metal and metalloid compounds having hydrolyzable ligands that can undergo a sol-gel reaction and form sol-gels. Suitable hydrolyzable ligands include hydroxyl, alkoxy, halo, amino, or acylamino, without limitation. The most common metal oxide participating in the sol-gel reaction is silica, though other metals and metalloids can also be useful in small quantities, such as zirconia, vanadia, titania, niobium oxide, tantalum oxide, tungsten oxide, tin oxide, hafnium oxide and alumina, or mixtures or composites thereof, having reactive metal oxides, halides, amines, etc., capable of reacting to form a sol-gel. Additional metal atoms that can be incorporated into the sol-gel precursors include magnesium, molybdenum, cobalt, nickel, gallium, beryllium, yttrium, lanthanum, tin, lead, and boron, without limitation.

In some embodiments, the metal oxides and alkoxides include, but are not limited to, silicon alkoxides, such as tetramethylorthosilane (TMOS), tetraethylorthosilane (TEOS), fluoroalkoxysilane, or chloroalkoxysilane, germanium alkoxides (such as tetraethylorthogermanium (TEOG)), vanadium alkoxides, aluminum alkoxides, zirconium alkoxides, and titanium alkoxides. Similarly, metal halides, amines, and acyloxy derivatives can also be used in the sol-gel reaction. In some embodiments, the sol-gel precursor is an alkoxide of silicon, germanium, aluminum, titanium, zirconium, vanadium, or hafnium, or mixtures thereof. In some embodiments, the sol-gel precursor is a silane, such as TEOS or TMOS. For forming a coating on silicon or a silica glass, silanes are preferred.

Sol-gel precursors can also serve as a fluorine source (i.e., a first fluorine source). For example, the sol-gel precursor can be a fluoroalkoxysilane, where the precursor has a preexisting bond to fluorine. After heating in the presence of water and/or a catalyst, the sol-gel precursors react to form oxides of the precursor metal having covalently bonded fluorine atoms.

The coating precursor solution can include an acid or base catalyst for controlling the rates of hydrolysis and condensation. The acid or base catalyst can be an inorganic or organic acid or base catalyst. Exemplary acid catalysts may be selected from the group comprising hydrochloric acid (HCl), nitric acid (HNO₃), sulfuric acid (H₂SO₄), acetic acid (CH₃COOH), p-toluenesulfonic acid and combinations thereof. Exemplary base catalysts include ammonium hydroxide and tetramethylammonium hydroxide (TMAH). The acid catalyst concentration can be from 0.0001 to 10 times the stoichiometric molar precursor (the film forming precursor). The acid catalyst concentration can be from 0.0001 to 0.1 times the molar precursor (the film forming precursor). The base catalyst concentration can be 0.001 to 10 times the stoichiometric molar precursor (the film forming precursor). The base catalyst concentration can be from 0.001 to 0.1 times the molar precursor (the film forming precursor). The amount of acid catalyst concentration can be from 0.001 to 0.1% (wt/wt) of the total weight of the sol-gel composition. The amount of base catalyst concentration can be from 0.001 to 0.1% (wt/wt) of the total weight of the sol-gel composition.

The coating precursor solution further includes a solvent system. The solvent system can include a non-polar solvent, a polar aprotic solvent, a polar protic solvent, and combinations thereof. Selection of the solvent system can be used to influence the timing of the sol-gel transition. Exemplary solvents include alcohols, for example, n-butanol, isopropanol, n-propanol (NPA), ethanol, methanol, and other well known alcohols. The amount of solvent can be from 80 to 95% (wt/wt) of the total weight of the sol-gel composition. The solvent system can further include water. The amount of water can be from 0.001 to 0.1% (wt/wt) of the total weight of the sol-gel composition. In certain embodiments, water may be present in 0.5 to 10 times the stoichiometric amount needed to hydrolyze the silicon containing precursor molecules.

### Particles

Particles can be further included in the coating precursor solution. In some embodiments, the particles are added to the sol-gel solution. In some embodiments, the particles are formed in the sol-gel solution. The particles can be porous or nonporous as desired to achieve a particular refractive index and antireflection capability.

In some embodiments, the coating precursor solution can further include nanoparticles, typically comprising silica. The nanoparticles may be of various shapes and sizes. The nanoparticles can be of various shapes and sizes, including spherical, cylindrical, prolate spheroid, and disc shaped. The particles can be silica nanoparticles having a smallest diameter of 5-100 nm, and a largest diameter of 15 to 200 nm. The nanoparticles in the cured coating can form a porous structure in the coating due to particle packing, where the coating acts as a binder to support and bond the particles together as well as bond the coating to the substrate. In this manner, the coating can also form a conformal coating, as described in co-owned, co-pending U.S. Ser. No. 13/195,119, herein incorporated by reference.

Exemplary nonporous silica nanoparticles are commercially available in sol form under the tradename ORGANOSILICASOL™ from Nissan Chemical America Corporation. Suitable commercially available products of that type include ORGANOSILICASOL™ DMAC-ST, ORGANOSILICASOL™ EG-ST, ORGANOSILICASOL™ IPA-ST, I ORGANOSILICASOL™ PA-ST-L, ORGANOSILICASOL™ IPA-ST-MS, ORGANOSILICASOL™ IPA-ST-ZL, ORGANOSILICASOL™ MA-ST-M, ORGANOSILICASOL™ MEK-ST, ORGANOSILICASOL™ MEK-ST-MS, ORGANOSILICASOL™ MEK-ST-UP, ORGANOSILICASOL™ MIBK-ST and ORGANOSILICASOL™ MT-ST.

In certain embodiments, the silica nanoparticles can be generated in-situ. One exemplary sol-gel composition for in-situ generation of silica nanoparticles includes a silane precursor (e.g., TEOS), water, a base catalyst (e.g., TMAH), and an alcohol solvent (e.g. n-propyl alcohol (NPA)). The components may be mixed for twenty-four hours at room or elevated (˜60° C.) temperatures as discussed above. This process is described, for example, in U.S. Pat. No. 3,634,558 to Stober, incorporated by reference herein.

In certain embodiments where a porous coating is desired, the sol-gel composition can further include both silica nanoparticles and porosity forming agents (porogens) to create a distribution of pores of varying sizes. The pores can comprise a first set of pores formed by extraction or combustion of the porogen in the polymeric network or matrix (e.g. the Si—O—Si network) and a second set of pores formed by the voids in particle packing in the polymeric network or matrix.

### Fluorine Sources

In some embodiments, fluorine sources include precursor materials having a preexisting Si—F bond. In some embodiments, fluorine sources include fluorogenic precursor materials that evolve reactive fluorine species during the curing process. In some embodiments, fluorine sources include reactive fluorine species in the form of gases or plasmas.

Precursor materials having a preexisting Si—F bond include fluorosilanes such as fluoroalkoxysilanes, fluorohalosilane, or silicon trifluoroacetate. Fluoroalkoxysilanes include FSi(OR)₃, where R is lower alkyl. Exemplary fluoroalkoxysilanes include fluorotriethoxysilane (TEFS), fluorotrimethoxysilane, and the like. Fluorohalosilanes include for example, FSiCl₃. These materials produce a fluorine doped xerogel coating when the coating is cured.

Fluorogenic precursors include fluorinated and/or fluoride containing compounds that can generate HF through hydrolysis or dissociation in the solution, optionally before or during the curing process. In some embodiments, reactive fluorine species are evolved upon mixing of the components of the coating precursor solution. In some embodiments, reactive fluorine species are evolved upon heating the coating precursor solution on the substrate. Precursor materials that evolve reactive fluorine species during the curing process include fluorinated alcohols (e.g., trifluoromethanol, trifluoroethanol, etc.), soluble fluoride compounds (e.g., NH₄F, H₂SiF₆, NH₄HF₂, C(NH₂)₃F, nonaqueous HF, etc.), fluorinated carboxylic acids (e.g., trifluoroacetic acid, fluoroacetic acid, etc.), fluorinated amines (e.g., perfluoroethanamine, etc.), silicon trifluoroacetate (as described, for example, in U.S. Pat. No. 5,948,928) and so forth. For example, fluorine from thermal decomposition of TFA is incorporated into the coating during heat treatment of the coating. The thermal decomposition of TFA results in a variety of fluorine containing reactive gases that react with Si—OH groups to produce Si—F bonds. In another embodiment, the thermal decomposition of NH₄F forms HF and NH₃ vapor, where the HF reacts with Si—OH to form Si—F bonds. Fluorogenic precursors can also include fluorinated surfactants (both carbon based and silicone based) that generate reactive fluorine upon thermal decomposition.

Fluorine sources can include, without limitation, reactive fluorine gas, liquid, or plasma. For example, fluorine sources can include F₂ (gas), HF (gas), or plasmas containing reactive fluorine formed from CF₄, C₂F₆, COF₂, HF, fluorosilanes (e.g., SiFH₃), fluorides of group V elements such as NF₃, fluorides of Group VI elements such as SF₄, SF₆, as well as fluoride salts such as NH₄F, NH₄HF₂, or mixtures of the above fluorine sources.

### Porogens

Porogens can be included in the coating precursor solution to introduce porosity when using the sol-gel process. The choice of porogen is not particularly limiting, so long as it enhances the porosity or provides a target porosity to the cured sol-gel coating. The porogen can be a surfactant selected from non-ionic surfactants, cationic surfactants, anionic surfactants, or combinations thereof. Exemplary non-ionic surfactants include non-ionic surfactants with linear hydrocarbon chains and nonionic surfactants with hydrophobic trisiloxane groups. The porogen can be a trisiloxane surfactant. Exemplary porogens can be selected from the group comprising: polyoxyethylene stearyl ether, benzoalkoniumchloride (BAC), cetyltrimethylammoniumbromide (CTAB), 3-glycidoxypropyltrimethoxysilane (Glymo), polyethyleneglycol (PEG), ammonium lauryl sulfate (ALS), dodecyltrimethylammoniumchloride (DTAC), polyalkyleneoxide modified hepta-methyltrisiloxane, and combinations thereof. Exemplary porogens are commercially available from Momentive Performance Materials under the tradename SILWET® surfactant and from SIGMA ALDRICH® under the tradename BRIJ® surfactant. Suitable commercially available products of that type include SILWET® L-77 surfactant and BRIJ® 78 surfactant. The porogen can comprise at least 0.1% (wt/wt), 0.5% (wt/wt), 1% (wt/wt), or 3% (wt/wt) of the total weight of the sol-gel composition. The porogen can comprise at least 0.5% (wt/wt), 1 v % (wt/wt), 3% (wt/wt) or 5% (wt/wt) of the total weight of the sol-gel composition. The porogen can be present in the sol-gel composition in an amount between about 0.1% (wt/wt) and about 5% (wt/wt) of the total weight of the sol-gel composition. In some embodiments, the porogen is a surfactant such as Sylwet L-77 and is added to the coating precursor solution at a weight % from 0.001 to 10%.

Polymers can also be utilized as porogens. For example, dissolved organic polymers, such as polystyrene sulfonic acid, polyacrylic acid, polyallylamine, polyethylene-imine, polyethylene oxide, or polyvinyl pyrrolidone, can be included to introduce pores during hydrolysis and polymerization of the sol-gel precursors, as described in U.S. Pat. No. 5,009,688 to Nakanishi. Preparation of the sol-gel in the presence of the phase separated volumes provides a sol-gel possessing macropores and/or large mesopores, which provide greater porosity to the sol-gel.

In one embodiment, the porogen can be a hydrophilic polymer. The amount and hydrophilicity of the hydrophilic polymer in the sol-gel forming solution affects the pore volume and size of macropores formed, and generally, no particular molecular weight range is required, although a molecular weight between about 1,000 to about 1,000,000 g/mole is preferred. The porogen can be selected from, for example, polyethylene glycol (PEG), sodium polystyrene sulfonate, polyacrylate, polyallylamine, polyethyleneimine, poly(acrylamide), polyethylene oxide, polyvinylpyrrolidone, poly(acrylic acid), and can also include polymers of amino acids, and polysaccharides such as cellulose ethers or esters, such as cellulose acetate, or the like. In some embodiments, the porogen is a polymer such as polyethylene glycol and is added to the coating precursor solution at a weight % of 0.001 to 5%. In some embodiments, hydroxylated fluoropolymers such as ACG Lumiflon can be utilized as porogens. In these embodiments, the fluorinated porogen can also serve as a fluorogenic precursor and result in fluorine doping during curing to form the xerogel.

The porogen can be an organic solvent so long as the porogen is phase separated from the sol-gel forming solution and forms micelles in the solution. The size of the micelles of porogen is related to the size of the pores formed. The porogen can be removed during drying or pyrolized during the curing process.

### Advantages and Applications

The methods and compositions described herein can be utilized in the manufacture of glasses, solar panels, electronic displays, optics, optical devices such as prisms and lenses, and the like, without limitation. Improved durability, resistance to chemical and UV degradation and soiling resistance is advantageously provided by adaptation of the formulations and processing methods described herein. The addition of fluorine dopants into the antireflection coating increases the durability to chemical and radiation-induced degradation, decreases the refractive index and imparts hydrophobic character to the coating. The fluorine-doped antireflection coatings demonstrate improved resistance to chemical attack by agents used in chemical durability testing and environmental exposure (e.g., water, NaOH, salt spray, SOₓ, NOₓ, UV). Fluorine-doping reduces surface energy, decreasing affinity to and wetting by polar species (water, aqueous bases and acids, etc.), which provides additional resistance to corrosion and fouling of the antireflection coating surface by dirt and dust.

In addition, fluorine-doping potentially increases the cohesive and adhesive strength of the antireflection coating by promoting condensation of silanols (Si—OH) into siloxane (Si—O—Si) bonds at low temperatures. For example, the presence of F⁻ and NH₃ promotes the condensation of nearby Si—OH bonds (chemical curing) which leads to additional durability improvement. The combined action of F⁻ and NH₃ also promotes the dissolution-precipitation of SiO₂ to bridge touching particles, further increasing durability by chemical sintering. Fluorine doping further improves stability at higher temperatures due to the increased strength of the Si—F bond (135 kcal/mol) vs. Si—O bond (110 kcal/mol).

The fluorine-doping methods described herein can be incorporated into existing antireflection coating manufacturing methods without requiring changes to the workflow or significant modification to the process or equipment. Fluorine-doped precursor formulations are cost-competitive with existing formulations.

### EXAMPLES

### Example 1

### Fluorine-Doped Silica Particle-Binder Xerogel Precursor Using FSi(OC₂H₅ as a Fluorine Source

A solution precursor suitable for curtain, dip, meniscus, roll or spin coating is prepared. The solution precursor comprises (by volume at 20° C.) 0.1-10 parts triethoxyfluorosilane (TEFS, FSi(OC₂H₅)₃), 0-10 parts tetraethoxysilane (TEOS, Si(OC₂H₅)₄), 1-20 parts IPA-ST-UP silica nanoparticles (15% by weight in IPA), 0-5 parts glacial acetic acid, 0-5 parts deionized water and 0-100 parts n-propanol (NPA, C₃H₇OH). The mixture is homogenized at 20-30° C. for 0.01 to 24 hours, and then diluted with NPA to the desired final concentration for coating. Fluorine is incorporated into the coating through hydrolysis and condensation of TEFS with itself and with TEOS and IPA-ST-UP.

### Example 2

### Fluorine-Doped Silica Xerogel Precursor Using FSi(OC₂H₅)₃ as a Fluorine Source

A solution precursor suitable for curtain, dip, meniscus, roll or spin coating is prepared. The solution precursor comprises (by volume at 20° C.) 1-20 parts triethoxyfluorosilane (TEFS, FSi(OC₂H₅)₃), 0-20 parts tetraethoxysilane (TEOS, Si(OC₂H₅)₄), 0-5 parts glacial acetic acid, 0-10 parts deionized water and 0-100 parts n-propanol (NPA, C₃H₇OH). The mixture is homogenized at 20-30° C. for 0.01 to 24 hours, and then diluted with NPA to the desired final concentration for coating. Fluorine is incorporated into the coating through hydrolysis and condensation of TEFS with itself and with TEOS.

### Example 3

### Fluorine-Doped Silica Particle-Binder Xerogel Precursor Using TFA as a Fluorine Source and Catalyst

A solution precursor suitable for curtain, dip, meniscus, roll or spin coating is prepared. The solution precursor comprises (by volume at 20° C.) 0-10 parts tetraethoxysilane (TEOS, Si(OC₂H₅)₄), 1-20 parts IPA-ST-UP silica nanoparticles (15% by weight in IPA), 0.0001-5 parts anhydrous trifluoroacetic acid (TFA, CF₃COOH), 0-10 parts deionized water and 0-100 parts n-propanol (NPA, C₃H₇OH). The mixture is homogenized at 20-30° C. for 0.01 to 24 hours, and then diluted with NPA to the desired final concentration for coating. Fluorine is incorporated into the coating during heat treatment of the coating, thermally decomposing the TFA into a variety of fluorine containing reactive gases that react with Si—OH groups, CO₂, CO and H₂O vapor.

### Example 4

### Fluorine-Doped Silica Particle-Binder Xerogel Precursor Using NH₄F as a Fluorine Source

A solution precursor suitable for curtain, dip, meniscus, roll or spin coating is prepared. The solution precursor comprises (by volume at 20° C.) 0-10 parts tetraethoxysilane (TEOS, Si(OC₂H₅)₄), 1-20 parts IPA-ST-UP silica nanoparticles (15% by weight in IPA), 0.001-5 parts glacial acetic acid (HOAc, CH₃COOH), 0.0001-5 wt % NH₄F, 0-10 parts deionized water and 0-100 parts n-propanol (NPA, C₃H₇OH). The mixture is homogenized at 20-30° C. for 0.01 to 24 hours, and then diluted with NPA to the desired final concentration for coating. Fluorine is incorporated into the coating during the sol-gel process by substitution of F for Off in the silica, and during heat treatment of the coating, thermally decomposing the NH₄F into HF and NH₃ vapor, where the HF reacts with Si—OH and form Si—F.

### Example 5

### Fluorine-Doped Silica Particle-Binder Xerogel Precursor Using F₂ or CF₄ as a Fluorine Source

A solution precursor suitable for curtain, dip, meniscus, roll or spin coating is prepared. The solution precursor comprises (by volume at 20° C.) 0-10 parts tetraethoxysilane (TEOS, Si(OC₂H₅)₄), 1-20 parts IPA-ST-UP silica nanoparticles (15% by weight in IPA), 0.001-5 parts glacial acetic acid (HOAc, CH₃COOH), 0-10 parts deionized water and 0-100 parts n-propanol (NPA, C₃H₇OH). The mixture is homogenized at 20-30° C. for 0.01 to 24 hours, and then diluted with NPA to the desired final concentration for coating. Fluorine is incorporated into the coating by passing F₂ or CF₄ vapor over the cured or heat-treated coating, or by passing a CF₄ containing plasma discharge over the cured or heat-treated coating at temperatures of 10-300° C.

### Example 6

### Fluorine-Doped Silica Xerogel Precursor Using FSi(OC₂H₅)₃ as a Fluorine Source and Sylwet-77 as Surfactant Porogen

A solution precursor suitable for curtain, dip, meniscus, roll or spin coating is prepared. The solution precursor comprises (by volume at 20° C.) 1-20 parts triethoxyfluorosilane (TEFS, FSi(OC₂H₅)₃), 0-20 parts tetraethoxysilane (TEOS, Si(OC₂H₅)₄), 0-5 parts glacial acetic acid, 0-10 parts deionized water and 0-100 parts n-propanol (NPA, C₃H₇OH). The mixture is homogenized at 20-30° C. for 0.01 to 24 hours, and then diluted with NPA to the desired final concentration for coating. Sylwet L-77 surfactant is added to the final solution at a weight % from 0.001 to 10%, which act as a porogen. Fluorine is incorporated into the coating through hydrolysis and condensation of TEFS with itself and with TEOS.

### Example 7

### Fluorine-Doped Silica Particle-Binder Xerogel Precursor Using TFA as a Fluorine Source and Catalyst and PEG as Polymeric Porogen and Gelling Agent

A solution precursor suitable for curtain, dip, meniscus, roll or spin coating is prepared. The solution precursor comprises (by volume at 20° C.) 0-10 parts tetraethoxysilane (TEOS, Si(OC₂H₅)₄), 1-20 parts IPA-ST-UP silica nanoparticles (15% by weight in IPA), 0.0001-5 parts anhydrous trifluoroacetic acid (TFA, CF₃COOH), 0-10 parts deionized water and 0-100 parts n-propanol (NPA, C₃H₇OH). The mixture is homogenized at 20-30° C. for 0.01 to 24 hours, and then diluted with NPA to the desired final concentration for coating. Polyethylene glycol at a weight % of 0.001 to 5% is added to the final solution as a porogen and stirred until completely mixed. Fluorine is incorporated into the coating during heat treatment of the coating, thermally decomposing the TFA into a variety of fluorine containing reactive gases that react with Si—OH groups, CO₂, CO and H₂O vapor.

It will be understood that the descriptions of one or more embodiments of the present invention do not limit the various alternative, modified and equivalent embodiments which may be included within the spirit and scope of the present invention as defined by the appended claims. Furthermore, in the detailed description above, numerous specific details are set forth to provide an understanding of various embodiments of the present invention. However, one or more embodiments of the present invention may be practiced without these specific details. In other instances, well known methods, procedures, and components have not been described in detail so as not to unnecessarily obscure aspects of the present embodiments.

1.-8. (canceled)

9. A method of making an antireflection coating on a glass substrate comprising
applying a coating precursor solution comprising a sol-gel precursor to a glass substrate,
heating the coating precursor solution to form a xerogel coating, and
fluorine-doping the coating such that fluorine is covalently incorporated as Si—F bonds;
wherein the fluorine-doping is performed by one or more of the following: utilizing a coating precursor solution comprising a first fluorine source, contacting the xerogel coating with a second fluorine source, or a combination thereof; and
wherein a refractive index of the xerogel coating is less than a refractive index of the glass substrate.

10. The method of claim 9, wherein the coating precursor solution further comprises an acid catalyst, a base catalyst, water, a nonaqueous solvent, or mixtures thereof.

11. The method of claim 9, wherein the first fluorine source is a fluorinated sol-gel precursor having a Si—F bond, a fluorogenic precursor, a soluble fluoride compound, or mixtures thereof.

12. The method of claim 11, wherein the fluorogenic precursor is a fluorinated alcohol, fluorinated carboxylic acid, fluorinated amine, fluorinated surfactant, fluorinated polymer, or fluoride.

13. The method of claim 11, wherein the fluorinated sol-gel precursor having a Si—F bond is a fluoroalkoxysilane, fluorohalosilane fluorosilanes, FSi(OR)₃, FSiCl₃, or silicon trifluoroacetate.

14. The method of claim 11, wherein the soluble fluoride compound is NH₄F, HF, F₂, H₂SiF₆, NH₄HF₂, C(NH₂)₃F.

15. The method of claim 9, wherein the second fluorine source is a reactive fluorine gas, liquid, or plasma.

16. The method of claim 15, wherein the second fluorine source is CF₄, C₂F₆, COF₂ or HF(g).

17. The method of claim 9, wherein the coating precursor solution further comprises nanoparticles.

18. The method of claim 9, wherein the coating precursor solution further comprises a porogen.

19. The method of claim 18, wherein the porogen is a surfactant, a polymer, or a water immiscible solvent.

20. (canceled)

21. The method of claim 9, wherein the first fluorine source is a fluorinated sol-gel precursor having a Si—F bond.

22. The method of claim 9, wherein the first fluorine source is a fluorogenic precursor.

23. The method of claim 9, wherein the first fluorine source is a soluble fluoride compound.

24. A method of making an antireflection coating on a glass substrate comprising
applying a coating precursor solution comprising a sol-gel precursor to a glass substrate,
heating the coating precursor solution to form a xerogel coating, and
fluorine-doping the coating such that fluorine is covalently incorporated as Si—F bonds;
wherein the fluorine-doping is performed by utilizing a coating precursor solution comprising a fluorinated sol-gel precursor having a Si—F bond, a fluorogenic precursor, a soluble fluoride compound, or mixtures thereof; and
wherein a refractive index of the xerogel coating is less than a refractive index of the glass substrate.

25. The method of claim 24, wherein the fluorinated sol-gel precursor having a Si—F bond is a fluoroalkoxysilane, fluorohalosilane, or silicon trifluoroacetate.

26. The method of claim 24, wherein the fluorogenic precursor is a fluorinated alcohol, fluorinated carboxylic acid, fluorinated amine, fluorinated surfactant, fluorinated polymer, or fluoride.

27. The method of claim 24, wherein the soluble fluoride compound is NH₄F, HF, F₂, H₂SiF₆, NH₄HF₂, or C(NH₂)₃F.

28. A method of making an antireflection coating on a glass substrate comprising
applying a coating precursor solution comprising a sol-gel precursor to a glass substrate,
heating the coating precursor solution to form a xerogel coating, and
contacting the xerogel coating with a fluorine source such that fluorine is covalently incorporated as Si—F bonds;
wherein the fluorine source is a reactive fluorine gas, liquid, or plasma, and
wherein a refractive index of the xerogel coating is less than a refractive index of the glass substrate.

29. The method of claim 28, wherein the fluorine source is CF₄, C₂F₆, COF₂ or HF(g).
